(19) United States
(12) Patent Application Publication
(10) Pub. No.: US 2025/0373429 A1
(43) Pub. Date: Dec. 4, 2025

(54) METHOD, APPARATUS AND RECORDING MEDIUM FOR DETERMINING VALIDATION OF TICKET

(71) Applicants: Hyundai Card Co., Ltd., Seoul (KR); MODERN LION Co., Ltd., Seoul (KR)

(72) Inventor: Du Hee LEE, Seoul (KR)

(21) Appl. No.: 18/959,640

(22) Filed: Nov. 26, 2024

(30) Foreign Application Priority Data
May 28, 2024 (KR) 10-2024-0069155

(51) Int. Cl. H04L 9/32; G06F 21/32; G06K 7/14; G06Q 10/02; G06Q 20/36

(52) U.S. Cl. CPC H04L 9/3213; G06F 21/32; G06K 7/1404; G06Q 10/02; G06Q 20/36

(57) ABSTRACT

A node device according to various embodiments of the present disclosure may determine whether a code displayed on a terminal of a user and recognized by a reader provided at an event venue of an event is valid by executing a smart contract related to the event. The smart contract may include instructions to determine whether the code is valid, based on first ticket information including information corresponding to each of one or more first non-fungible tokens (NFTs) minted in association with the event and encrypted information, upon obtaining the encrypted information corresponding to the code from the reader that recognizes the code.

### CROSS-REFERENCE TO RELATED APPLICATION

This application is based upon and claims the benefit of priority from Korean Patent Application No. 10-2024-0069155, filed on May 28, 2024, the entire contents of which are incorporated herein by reference.

### TECHNICAL FIELD

The present disclosure relates to a technology for determining the validity of a ticket.

### BACKGROUND

To determine and verify the validity of a ticket, whether various pieces of information related to the ticket are valid may be identified. For example, validity verification may include checking whether the date on which the ticket is issued, the expiration date of the ticket, the identity of an issuer, the identity of a ticket owner, and the name of an event are valid. For validity verification, various security technologies and safety elements may be used.

### SUMMARY

According to various embodiments of the present disclosure, there is provided a technique for determining the validity of a ticket by transmitting encrypted information obtained by a reader from a terminal to an address of a smart contract in a situation where communication between the terminal and a server is impossible but the reader is connected to a computer network.

According to various embodiments of the present disclosure, there is provided a technique for determining the validity of a ticket by reflecting a change in the ownership of a ticket in real time as a node device executes a smart contract since a reader is connected to a computer network even though the change in the ownership is not limited from a certain time prior to the start time of an event.

According to various embodiments of the present disclosure, there is provided a technique for determining the validity of a ticket as a terminal transmits encrypted information related to the ticket to an address of a smart contract and a node device executes the smart contract in a situation where the terminal is connected to a computer network.

According to various embodiments of the present disclosure, there is provided a technique for a server to retransmit encrypted information about a terminal to an address of a smart contract when the server monitors the encrypted information about the terminal transmitted to the address of the smart contract and the encrypted information about the terminal is not transmitted to the address of the smart contract.

According to various embodiments of the present disclosure, there is provided a technique for determining the validity of a ticket corresponding to a non-fungible token.

According to various embodiments of the present disclosure, there is provided a technique for preventing an illegal transaction of a ticket corresponding to a non-fungible token.

According to various embodiments of the present disclosure, there is provided a technique for preventing an illegal transaction of a ticket even in a situation where communication between a terminal and a computer network is impossible.

In an embodiment, a method performed when a node device including one or more processors and one or more memories that store instructions to be executed by the one or more processors executes a smart contract may include determining whether a code displayed on a terminal of a user and recognized by a reader provided at an event venue of an event is valid by executing the smart contract related to the event, wherein the smart contract may include instructions to determine whether the code is valid, based on first ticket information including information corresponding to each of one or more first non-fungible tokens (NFTs) minted in association with the event and encrypted information, upon obtaining the encrypted information corresponding to the code from the reader that recognizes the code, and the encrypted information may be information encrypted by the terminal, based on at least one of identification information of a second non-fungible token or an address of the smart contract, wherein the second non-fungible token is one of the one or more first non-fungible tokens.

In an embodiment, the smart contract may further include: instructions to mint the one or more first non-fungible tokens, based on a number of tickets for the event, upon receiving a ticket issuance request from a server; and store the first ticket information including the information corresponding to each of the one or more first non-fungible tokens in a blockchain. In an embodiment, the smart contract may further include instructions to transmit the second non-fungible token, which is one of the first non-fungible tokens, to a wallet of the user upon receiving a ticket purchase request from the user.

In an embodiment, the smart contract may include instructions to transmit at least one of the address of the smart contract or the identification information of the second non-fungible token to the terminal.

In an embodiment, the smart contract may further include instructions to update the first ticket information, based on a change in identification information of the user that corresponds to the identification information of the second non-fungible token.

In an embodiment, the instruction to determine whether the code is valid may include instructions to determine whether the code is valid, based on the updated first ticket information and the encrypted information.

In an embodiment, the smart contract may further include instructions to decrypt the encrypted information to obtain at least one of the address of the smart contract or the identification information of the second non-fungible token.

In an embodiment, the instruction to determine whether the code is valid may include instructions to determine whether the code is invalid when the encrypted information fails to be decrypted.

In an embodiment, the instruction to determine whether the code is valid may include instructions to determine whether the code is valid, based on at least one of the first ticket information, the address of the smart contract, or the identification information of the second non-fungible token.

In an embodiment, the encrypted information may be information encrypted based on a first encryption key and first time information for a first time interval corresponding to a time when the terminal encrypts the identification information of the second non-fungible token, and the instruction to decrypt the encrypted information to obtain at least one of the address of the smart contract or the identification information of the second non-fungible token may include: instructions to first decrypt the encrypted information, based on second time information for a second time interval corresponding to a time when the encrypted information is decrypted; and secondly decrypt the first decrypted encrypted information, based on a second encryption key associated with the first encryption key and stored in the smart contract.

In an embodiment, the instruction to determine whether the code is valid may include: instructions to determine whether identification information of a non-fungible token matching the identification information of the second non-fungible token exists in the first ticket information; and determine that the code is valid according to determination that the identification information of the non-fungible token matching the identification information of the second non-fungible token exists in the first ticket information.

In an embodiment, the instruction to determine whether the code is valid may include: instructions to obtain the identification information of the user; determine whether a correspondence between the identification information of the second non-fungible token and the identification information of the user exists in the first ticket information; and determine that the code is valid according to determination that the correspondence exists in the first ticket information.

In an embodiment, the instruction to determine whether the code is valid may include: instructions to determine whether the address of the smart contract obtained by decrypting the encrypted information matches an address of a smart contract included in the first ticket information; and determine that the code is valid according to determination that the address of the smart contract obtained by decrypting the encrypted information matches the address of the smart contract included in the first ticket information.

In an embodiment, the smart contract may further include instructions to transmit ticket-related metadata corresponding to the second non-fungible token to the reader according to determination that the code is valid.

In an embodiment, the ticket-related metadata may include information about at least one of a name of the event, a schedule, a location, a seat identifier of a ticket, a price, a purchase condition, or the user.

In an embodiment, the smart contract may further include instructions to transmit a signal enabling a server to transmit coupon information corresponding to the second non-fungible token to the reader to the server according to determination that the code is valid.

In an embodiment, the smart contract may further include instructions to obtain the encrypted information from the terminal or a server, the encrypted information may be transmitted from the terminal to the server, and the server transmits the encrypted information to the address of the smart contract upon the encrypted information not being received to the address of the smart contract.

In an embodiment, the smart contract may further include instructions to cause the server to pay a fee for a transaction for the terminal to transmit the encrypted information to the address of the smart contract.

In an embodiment, a method performed in a reader including one or more processors and one or more memories that store instructions to be executed by the one or more processors may include: recognizing, by the one or more processors, a code displayed on a terminal of a user; obtaining encrypted information corresponding to the code, the encrypted information being information encrypted by the terminal, based on at least one of identification information of a second non-fungible token, which is one of one or more first non-fungible tokens associated with an event, or an address of a smart contract; and transmitting a transaction for a request to determine whether the code is valid to the address of the smart contract, wherein the smart contract may include instructions to determine whether the code is valid, based on first ticket information including information corresponding to each of the one or more first non-fungible tokens and the encrypted information, upon obtaining the encrypted information corresponding to the code from the reader that recognizes the code.

In an embodiment, an application that provides a service for trading the one or more first non-fungible tokens may be installed in the terminal, and the code may be displayed through the application.

In an embodiment, the code may be displayed on a screen of the terminal, based on a result of biometric authentication of the user performed on the terminal.

In another embodiment, a node device may include: one or more processors; and one or more memories that store instructions to be executed by the one or more processors, wherein, when the instructions are executed, the one or more processors may determine whether a code displayed on a terminal of a user and recognized by a reader provided at an event venue of an event is valid by executing a smart contract related to the event, the smart contract may include instructions to determine whether the code is valid, based on first ticket information including information corresponding to each of one or more first non-fungible tokens minted in association with the event and encrypted information, upon obtaining the encrypted information corresponding to the code from the reader that recognizes the code, and the encrypted information may be information encrypted by the terminal, based on at least one of identification information of a second non-fungible token or an address of the smart contract, wherein the second non-fungible token is one of the one or more first non-fungible tokens.

In another embodiment, a non-transitory computer-readable recording medium may record instructions to be executed by one or more processors, wherein, when executed, the instructions may cause the one or more processors to determine whether a code displayed on a terminal of a user and recognized by a reader provided at an event venue of an event is valid by executing a smart contract related to the event, the smart contract may include instructions to determine whether the code is valid, based on first ticket information including information corresponding to each of one or more first non-fungible tokens minted in association with the event and encrypted information, upon obtaining the encrypted information corresponding to the code from the reader that recognizes the code, and the encrypted information may be information encrypted by the terminal, based on at least one of identification information of a second non-fungible token or an address of the smart contract, wherein the second non-fungible token is one of the one or more first non-fungible tokens.

### BRIEF DESCRIPTION OF DRAWINGS

The accompanying drawings, which are incorporated in and constitute a part of the specification, illustrate embodiments of the present disclosure.

FIG. 1 illustrates a system for determining the validity of a ticket according to various embodiments of the present disclosure;

FIG. 2 is a block diagram illustrating a node device according to various embodiments of the present disclosure;

FIG. 3 is a flowchart illustrating a method in which a reader transmits encrypted information to an address of a smart contract and a node device determines the validity of a ticket according to various embodiments of the present disclosure;

FIG. 4 is a flowchart illustrating a method in which a terminal transmits encrypted information to an address of a smart contract and a node device determines the validity of a ticket according to various embodiments of the present disclosure;

FIG. 5 is a flowchart illustrating a screen display method of a reader according to the result of determining the validity of a ticket according to various embodiments of the present disclosure;

FIG. 6 is a flowchart illustrating a method in which a node device determines the validity of a ticket according to various embodiments of the present disclosure;

FIG. 7 is a flowchart illustrating the operation of a reader according to various embodiments of the present disclosure.

### DETAILED DESCRIPTION

Embodiments of the present disclosure are illustrated for describing the technical idea of the present disclosure. The scope of the claims according to the present disclosure is not limited to embodiments to be illustrated below or a specific description.

Unless otherwise specified, all technical and scientific terms used herein have meanings that are generally understood by a person having ordinary knowledge in the art to which the present disclosure pertains. The terms used herein are selected for only more clear illustration of the present disclosure, and are not intended to limit the scope of claims in accordance with the present disclosure.

The expressions “include”, “provided with”, “have” and the like used herein should be understood as open-ended terms connoting the possibility of inclusion of other embodiments, unless otherwise mentioned in a phrase or sentence including the expressions.

A singular expression can include meanings of plurality, unless otherwise mentioned, and the same is applied to a singular expression stated in the claims.

The terms “first”, “second”, and the like used herein are used to identify a plurality of components from one another, and are not intended to limit the order or importance of the components.

The term “unit” used herein refers to a software component or a hardware component, such as a field-programmable gate array (FPGA) and an application specific integrated circuit (ASIC). However, a “unit” is not limited to software and hardware. A “unit” may be configured to be in an addressable storage medium, or may be configured to execute one or more processors. For example, a “unit” may include components, such as software components, object-oriented software components, class components, and task components, as well as processors, functions, attributes, procedures, subroutines, segments of program codes, drivers, firmware, micro-codes, circuits, data, databases, data structures, tables, arrays, and variables. Functions provided in components and “unit” may be combined into a smaller number of components and “units” or further subdivided into additional components and “units.”

The expression “based on” used herein is used to describe one or more factors that influence a decision, an action of judgment, or an operation described in a phrase or sentence including the relevant expression, and this expression does not exclude an additional factor influencing the decision, the action of judgment, or the operation.

It should be understood that when a certain component is described as being “coupled to” or “connected to” another component, the certain component may be coupled or connected directly to the other component, or the certain component may be coupled or connected to the other component via a new intervening component.

In the present disclosure, a “ticket” is a certificate that represents the right of a user to use a service or enter an event (e.g., a concert). The ticket may include defined conditions and restrictions, and the owner of the ticket may receive the service or participate in the event.

In the present disclosure, “validation of a ticket” may be determining whether a ticket holder has the right to use a service or enter an event. Accordingly, when the ticket is valid, the ticket holder may use the service or enter the event. However, when the ticket is invalid, the ticket holder is not allowed to use the service or enter the event.

The term “blockchain network” (hereinafter, referred to as “blockchain”) used herein may include two or more nodes that manage a blockchain. A block may refer to a specific data type. A blockchain may refer to a data structure in which one or more blocks are connected in a chain form. The one or more blocks included in the blockchain may be independently stored respectively in a plurality of nodes included in a blockchain network, or may be stored in a plurality of nodes in a distributed manner. The block is a data structure including a plurality of transaction records. Each block includes transaction data, a timestamp, a hash value of a previous block, and a hash value of the block. The hash value ensures the integrity of the block, and functions as a connecting link to the previous block in the blockchain. This structure is made in such a manner that blocks are linked to timestamps and are sequentially connected in a chain, and all blocks have a security attribute of preventing the chain from being changed. For example, the block may include a block hash value, a block header, or a block body. The block hash value is unique information for identifying the block, and may be, for example, a character string expressed in 256 bits. The block header may include, for example, at least one of version information about software or a protocol, a hash value of a previous block according to an order in which the blocks are connected in the blockchain, a Merkle root, time information indicating a time when the block is generated, bits indicating difficulty of calculation, or a nonce that is a value needed in a mining process for adding a new block to the block chain. The block body may include at least one transaction. The transaction is a set of pieces of data having a specific data structure, and may be a unit of information stored in the block body. The transaction may include information about generation or trading of a token.

Each of at least one node included in the blockchain may be referred to as a “participant” in the blockchain. At least one node included in the blockchain may be operated by a hierarchical structure. The hierarchical structure may include, for example, at least one of a data layer that defines a structure of data handled by the blockchain and manages the data, a consensus layer that verifies the validity of a block, performs mining of generating a block, and is in charge of processing a fee provided to a miner in a mining process, a common layer that implements or manages a P2P network protocol, a hash function, a digital signature, encoding, and a common storage, or an application layer that generates or processes various applications.

At least one node included in the blockchain may share or store a transaction recorded on the blockchain. In addition, at least one node included in the blockchain may verify a transaction transmitted to the blockchain through a consensus algorithm of the blockchain, and may perform a function of recording the verified transaction in a block on the blockchain when verification is completed. There is no restriction on the type of a consensus algorithm performed by the blockchain, and any type of consensus algorithm that is adoptable and modifiable by a person skilled in the art may be performed.

In the present disclosure, a “smart contract” is a specification or script written in a programming language, for example, Solidity, and may be a program or application operating on a virtual machine executed by at least one node included in a blockchain. The smart contract may be written such that a specific operation is executed when a specific condition is satisfied. The specific condition may be, for example, a condition that a specific type of token is input or a file in a specific format is input. The specific operation may be, for example, an operation of transmitting a specific type of token to an arbitrary node of the blockchain. Each of the at least one node included in the blockchain may store the smart contract. Accordingly, the at least one node included in the blockchain may share the same smart contract. Further, the smart contract may be recorded in one block on the blockchain managed by the blockchain.

In the present disclosure, a “digital asset wallet” (hereinafter, referred to as “wallet”) may be a tool for safely storing and managing a personal digital asset in an electronic form. The wallet may store and manage information related to a cryptocurrency or a digital asset. Each wallet may have an address, and when a node transfers a non-fungible token to a specific user, the non-fungible token may be transferred to the address of a wallet of the user.

In the present disclosure, a “non-fungible token (NFT)” is a blockchain-based token that represents the ownership of a digital asset. Each non-fungible token is not mutually interchangeable, and has a unique value. These key features are distinguished from those of traditional cryptocurrencies. Cryptocurrencies have the same value for certain units, and are mutually interchangeable. A non-fungible token is mainly used to certify the ownership of a performance, an artwork, music, a game item, and other collectible digital items. A non-fungible token is recorded on a blockchain, and a change in the owner of the non-fungible token is publicly verifiable.

Creation and transaction of a non-fungible token is performed by utilizing a smart contract function of a blockchain. A smart contract includes code for executing an operation, such as creation, transfer, and destruction of a non-fungible token.

In the present disclosure, a QR code is a heterogeneous matrix barcode known as a quick response code. The QR code records data with a pattern of black and white squares, is immediately readable, and is able to quickly process data. The QR code is able to store data in both horizontal and vertical directions due to the structure of the QR code, thus including much more information than a traditional barcode. A user may scan the QR code with a QR code reader, and may quickly obtain the information.

Hereinafter, embodiments of the present disclosure will be described with reference to the accompanying drawings. In the accompanying drawings, like or relevant components are indicated by like reference numerals. In the following description of embodiments, repeated descriptions of the identical or relevant components will be omitted. However, even if a description of a component is omitted, such a component is not intended to be excluded in an embodiment.

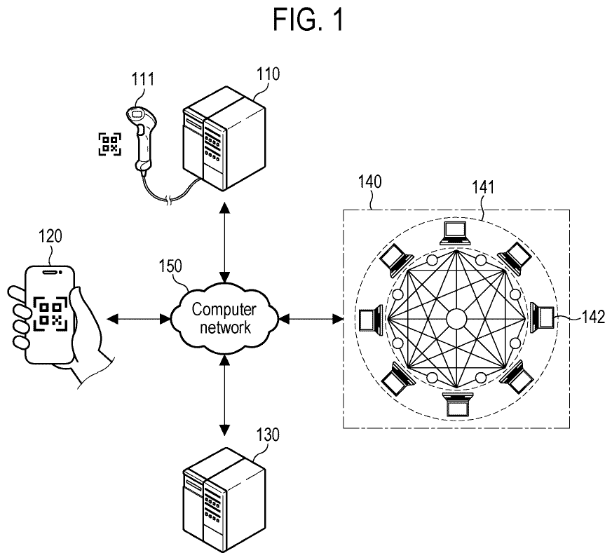

FIG. 1 illustrates a system for determining the validity of a ticket according to various embodiments of the present disclosure. The system may include a reader 110, a code recognition device 111 connected to a device, a terminal 120, a server 130, a blockchain network 140, and/or node devices 141 included in the blockchain network 140.

The reader 110 may be a device used to determine the validity of a ticket. For example, the reader 110 may be a device installed at the venue of an event. The reader 110 may include the code recognition device 111. The reader 110 may determine the validity of the ticket by using ticket information obtained through the code recognition device 111. The reader 110 and the server 130 may be connected with each other through a computer network 150 to transmit and receive the ticket information. The code recognition device 111 may obtain the ticket information from the terminal 120 by various methods. For example, the code recognition device 111 may obtain the ticket information from the terminal 120 by using a QR code, a bar code, near-field communication (NFC), and the like. In the present disclosure, the reader 110 or the code recognition device 111 may be referred to as the term “reader”.

The ticket information may include information related to the ticket corresponding to a non-fungible token. For example, the ticket information may include at least one of an address of a smart contract related to an event, identification information of the non-fungible token corresponding to the ticket information, metadata about the non-fungible token, or user identification information. The address of the smart contract may be a unique identifier indicating the corresponding smart contract on a blockchain. The address of the smart contract is an address required for execution of the smart contract or for interaction, and includes information required to record a transaction of a token or a transaction history of a token. The address of the smart contract may include a series of letters and numbers, and at least one of the node devices 141 may use the address of the smart contract to check the content and a condition of the smart contract or track a change. The identification information of the non-fungible token is unique information used to uniquely identify specific information or an item, and may include, for example, an ID of the non-fungible token. The metadata about the non-fungible token may include data related to at least one of the time when the non-fungible token is minted, issuer information, a transaction history, rental information, or ownership. In the present disclosure, the metadata about the non-fungible token may be ticket-related metadata. The ticket-related metadata may include information about the ticket for the event corresponding to the non-fungible token. The user identification information may be data for identifying a user, for example, at least one of the user's ID or the user's wallet address.

The present disclosure illustrates a method for determining the validity of the ticket by using some information of the ticket information. For example, the present disclosure illustrates a method for determining the validity of the ticket by using the identification information of the non-fungible token and the address of the smart contract among the ticket information as an example.

The terminal 120 may be a user terminal, and may be a terminal of the user who owns or rents the ticket to use a service or enter the event. A code may be displayed on a screen of the terminal 120. For example, a QR code may be displayed on the screen of the terminal 120, and the QR code may be recognized by the code recognition device 111.

The server 130 may be a device that manages various processes related to the event. For example, the server 130 may be a device that issues the smart contract related to the event, manages information about a ticket corresponding to each of one or more non-fungible tokens minted by the smart contract, or transmits ticket information to the reader 110.

At least one of the node devices 141 included in the blockchain network 140 may refer to a device of a participant participating in the blockchain network 140. At least one of the node devices 141 may be an element forming the blockchain network 140. At least one of the node devices 141 may perform an operation of maintaining a blockchain of the blockchain network 140. For example, any node of the blockchain network 140 may generate a new block of the blockchain, and the new block may be shared among other node devices of the blockchain through a distributed consensus process and be connected to a next block of the blockchain. That is, at least one of the node devices 141 may perform an operation of generating, verifying, or spreading a transaction and a block in which the transaction is recorded. At least one of the node devices 141 may mint a non-fungible token by interacting with the server 130. Minting a non-fungible token may mean a process in which an issuer generates a specific number of non-fungible tokens by using a smart contract and stores the generated non-fungible tokens in a wallet of the issuer.

At least one of the node devices 141 may be configured as a computing device. For example, the computing device may be a desktop computer, a laptop computer, or the like but is not limited thereto, and may be various types of devices having a computing function. In the present disclosure, at least one of the node devices 141 may be referred to as a node device 142. The node device 142 does not refer to a specific node in the blockchain network 140, but may be any one node or nodes among the node devices 141.

The computer network 150 is a telecommunication network, in which various distributed devices are connected via a predetermined communications network. The computer network 150 may be configured as any type of wired or wireless network, such as a local area network (LAN), a wide area network (WAN), a mobile radio communication network, or a wireless broadband Internet (Wibro).

In an embodiment, the node device 142 may obtain first ticket information including information corresponding to each of one or more non-fungible tokens (hereinafter, “first non-fungible tokens”) minted by the smart contract related to the event. The event may occur at a certain place and time by a specific entity. For example, the event may include a performance, an exhibition, an occasion, and the like. The smart contract related to the event may issue and manage a ticket allowing admission to the event. For example, the server 130 may transmit a transaction to the blockchain network 140 to cause at least one of the node devices 141 of the blockchain network 140 to execute the smart contract, and in this process, the smart contract may mint the one or more first non-fungible tokens related to the specific event. For example, when there are 500 tickets to performance A, 500 first non-fungible tokens corresponding to the respective tickets may be minted. The first ticket information may be a set of pieces of ticket information corresponding to the respective non-fungible tokens minted by the smart contract. Second ticket information may be ticket information corresponding to one non-fungible token (hereinafter, “second non-fungible token”) among the one or more first non-fungible tokens.

In an embodiment, the first ticket information may be stored in the blockchain network 140. The node device 142 may execute the smart contract, thereby determining the validity of the ticket by using the first ticket information. The first ticket information may also be stored in the server 130. The server 130 may repeatedly obtain the first ticket information from the blockchain network 140 at regular intervals.

In another embodiment, the reader 110 may receive the first ticket information from the server 130 or the node device 142. However, in the present disclosure, since the node device 142 determines the validity of the ticket by executing the smart contract, the reader 110 may not store the first ticket information. Since the reader 110 may recognize the code displayed on the terminal and may transmit encrypted information corresponding to the code to the address of the smart contract, thereby causing the node device 142 to determine the validity of the ticket, the reader 110 may not store the first ticket information. Since the reader 110 installed at the venue of the event does not store the first ticket information, it is possible to prevent an fraudulent act, such as hacking the reader 110 to obtain the first ticket information and then forging or faking the ticket information to have the ticket recognized as valid. Therefore, the first ticket information is stored in the blockchain network 140 and the node device 142 determines the validity of the ticket, making it possible to prevent a fraudulent act that may occur in a process of determining the validity of the ticket.

In an embodiment, the reader 110 may recognize a code displayed on the terminal 120 of the user associated with the second non-fungible token, thus obtaining encrypted information corresponding to the code. Since the reader 110 is connected to the computer network 150 and is able to receive the first ticket information in real time from the blockchain network 140, the reader 110 or the terminal 120 may not need to store additional information about the ticket, such as metadata related to the ticket. This is because when determining that the ticket is valid, the reader 110 may receive the additional information about the ticket from the blockchain network 140 and may display the same on a screen or transmit the same to the terminal 120. Accordingly, the reader 110 may verify the validity of the ticket by using the lightweight ticket information. Specifically, the encrypted information may include only minimum information necessary to determine the validity of the ticket. For example, the encrypted information may be encrypted based on at least one of identification information of the second non-fungible token or the address of the smart contract among various pieces of information included in the ticket information. Since the encrypted information includes only the minimum information, even though a third party intercepts the encrypted information, it is difficult to decrypt the encrypted information, and even though the encrypted information is decrypted, it is impossible to obtain the ticket-related metadata, and thus the encrypted information may be useless information for the third party.

In an embodiment, the user terminal (or terminal 120) does not need to be a terminal owned by the user, and may be a terminal occupied by the user. The user terminal 120 associated with the second non-fungible token may be a terminal of a user who owns a ticket corresponding to the second non-fungible token or a terminal of a user who rents the ticket. The code may be for obtaining the encrypted information, and may be recognized by the code recognition device 111. For example, the code may include an identification code included in a QR code, a barcode, or a radio-frequency identification (RFID) tag.

The node device 142 may determine whether the code is valid. In the present disclosure, determining whether a code is valid is the same as determining the validity of a ticket corresponding to the code. The node device 142 may determine whether the code displayed on the terminal 120 is valid, based on at least one of the identification information of the second non-fungible token or the address of the smart contract obtained by decrypting the encrypted information, and the first ticket information including the information corresponding to each of the one or more first non-fungible tokens. For example, the node device 142 may determine whether the code is valid, based on whether the identification information of the second non-fungible token and the address of the smart contract exist in the first ticket information.

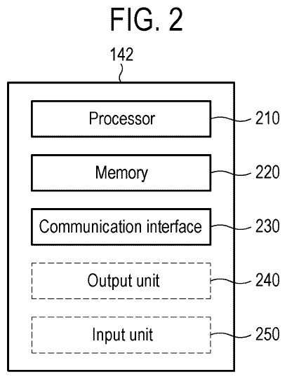

FIG. 2 is a block diagram illustrating a node device according to various embodiments of the present disclosure. The node device 142 may include one or more processors 210 and/or one or more memories 220. In an embodiment, some components of the node device 142 may be deleted, or other components (e.g., an output unit 240) may be added to the node device 142. Additionally or alternatively, some components may be configured in an integrated manner, or be configured as a single entity or a plurality entities. In the present disclosure, the one or more processors 210 may be expressed as a processor 210. The expression “processor 210” may refer to a set of one or more processors unless the context clearly indicates otherwise. Further, in the present disclosure, the one or more memories 220 may be expressed as a memory 220. The expression “memory 220” may refer to a set of one or more memories unless the context clearly indicates otherwise.

At least some components in the node device 142 may be connected with each other through a bus, a general purpose input/output (GPIO), a serial peripheral interface (SPI), or a mobile industry processor interface (MIPI) to exchange data or signals.

The processor 210 may perform calculation or data processing related to control or communication of each component of the node device 142. Specifically, the processor 210 may execute software (e.g., a command or a program) received from another component, thereby controlling at least one component of the node device 142 connected to the processor 210. For example, the processor 210 may load a command or data into the memory 220, may process a command or data stored in the memory 220, and may store resulting processed data in the memory 220. Further, the processor 210 may be operatively connected to the components of the node device 142 to perform various operations, such as calculation, processing, data generation, and handling, related to content disclosed in the present disclosure.

The memory 220 may store various data. The data stored in the memory 220 is data obtained, processed, or used by at least one component of the node device 142, and may include software (e.g., a command or a program). For example, the memory 220 may store commands for the operation of the processor 210 as a computer program. The computer program may include one or more commands that, when loaded into the memory 220, cause the processor 210 to perform an operation according to various embodiments of the content disclosed in the present disclosure. That is, the processor 210 may execute the foregoing one or more commands, thereby performing operations according to various embodiments of the content disclosed in the present disclosure. The memory 220 may include a volatile or nonvolatile memory. In an embodiment, the command or program is software stored in the memory 220, and may include an operating system for controlling a resource of the node device 142, an application, or middleware for providing various functions to an application so that the application may utilize resources of the node device 142.

In an embodiment, the node device 142 may further include a communication interface 230. The communication interface 230 may establish a wired or wireless communication channel with an external device (e.g., a server 130 or a user terminal 120), and may transmit and receive various data to and from the external device. In an embodiment, the communication interface 230 may include at least one port for connecting to the external device via a wired cable to communicate with the external device through a wire. In this case, the communication interface 230 may perform communication with the external device connected via the wire through the at least one port. In an embodiment, the communication interface 230 may be configured to connect to a cellular network (e.g., 3G, LTE, 5G, WiBro, or WiMax) by including a cellular communication module. In an embodiment, the communication interface 230 may include a short-range communication module to transmit and receive data to and from the external device by using short-range communication (e.g., Wi-Fi, Bluetooth, Bluetooth Low Energy (BLE), or UWB). In an embodiment, the communication interface 230 may include a contactless communication module for contactless communication. The contactless communication may include at least one contactless proximity communication technology, for example, NFC, radio-frequency identification (RFID) communication, or magnetic secure transmission (MST) communication. In addition to the various examples described above, the node device 142 may be configured by various known methods for communicating with the external device, and the scope of the present disclosure is not limited by the foregoing examples.

In an embodiment, the node device 142 may further include an output unit 240. The output unit 240 may display various screens, based on control of the processor 210. For example, the output unit 240 may display a dashboard visualizing token holding states of platform users, based on control of the processor 210. To display the dashboard on the output unit 240, for example, a web browser or a dedicated application may be installed in the node device 142. In an embodiment, the web browser or the dedicated application may be configured to provide a user with a token mint request function or a function of communication with other users through a user interface. Further, the output unit 240 is a component capable of interacting with the user, and may display various screens, based on control of the processor 210, and receive a user input from the user. The output unit 240 may be configured in the form of a touch sensor panel (TSP) capable of recognizing contact or proximity of various external objects (e.g., a finger or a stylus). The touch sensor panel may have various structures and types, and the content disclosed in the present disclosure may be applied regardless of the structure and type of the touch sensor panel. The output unit 240 may be omitted from the node device 142 according to an embodiment.

In an embodiment, the node device 142 may further include an input unit 250 (e.g., a mouse or a keyboard). The input unit 250 may receive data to be used for a component (e.g., the processor 210) of the node device 142 from an external source (e.g., the user) of the node device 142. The input unit 250 may be omitted from the node device 142 according to an embodiment.

In an embodiment, each of a reader 110, a terminal 120, and a server 130 may include one or more processors and/or one or more memories. The reader 110, the terminal 120, and the server 130 may further include a communication interface, an output unit, and/or an input unit. The foregoing configurations of the reader 110, the terminal 120, and the server 130 are merely examples, and the present disclosure is not limited thereto.

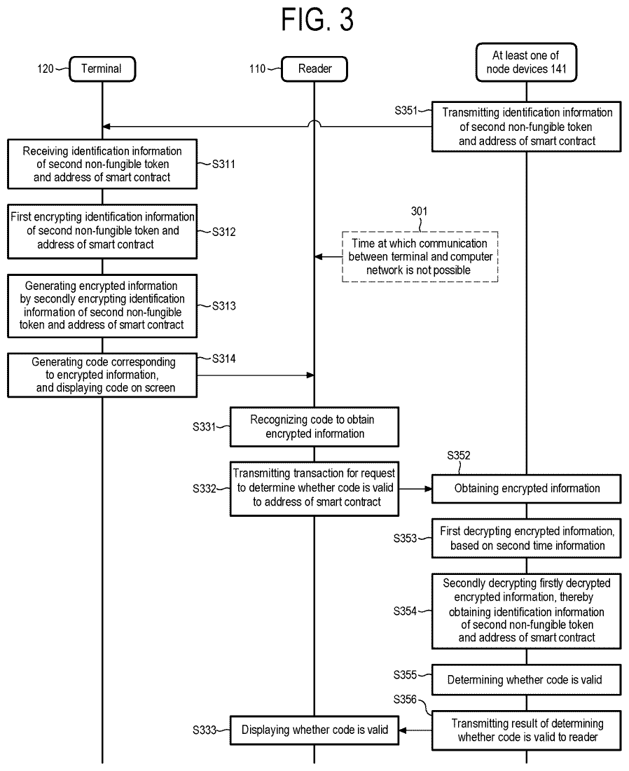

FIG. 3 is a flowchart illustrating a method in which a reader transmits encrypted information to an address of a smart contract and a node device determines the validity of a ticket according to various embodiments of the present disclosure.

When a large number of users gather at an event venue, terminals of the respective users may be disconnected from a computer network 150. When communication between a terminal 120 and the computer network 150 is impossible, it may be difficult to determine the validity of a ticket possessed by a user. According to the present disclosure, in this situation, the reader 110 includes a separate device to communicate with the computer network 150 via a wire or wirelessly, recognizes a code from the terminal 120 to obtain encrypted information, and then transmits the encrypted information to an address of a smart contract, thereby allowing a node device 142 to execute the smart contract to determine the validity of the ticket. Accordingly, the reader 110 may determine the validity of the ticket even in a situation where the terminal 120 is disconnected from the computer network 150. Hereinafter, a specific method for determining the validity of a ticket is described.

In an embodiment, at least one of node devices 141 (hereinafter, referred to as the “node device 142”) may transmit identification information of a second non-fungible token and an address of a smart contract to the terminal (S351). The smart contract may include instructions to transmit at least one of the address of the smart contract or the identification information of the second non-fungible token to the terminal 120. The node device 142 may perform operation S351 by executing the smart contract. The node device 142 may transmit the identification information of the second non-fungible token and the address of the smart contract to the terminal upon receiving a ticket purchase request from the terminal 120.

The terminal 120 may receive the identification information of the second non-fungible token and the address of the smart contract from the node device 142 (S311). The terminal 120 may first encrypt the identification information of the second non-fungible token and the address of the smart contract, based on a first encryption key (S312).

An encryption key is a specific code or a password used to encrypt or decrypt information. The encryption key may be used to protect information and to allow only an authorized user to access the information. In the present disclosure, for convenience of explanation, an encryption key stored in the terminal 120 is referred to as the first encryption key, and an encryption key stored in the reader 110 is referred to as a second encryption key. The first encryption key and the second encryption key may be the same or different. When the first encryption key and the second encryption key are the same, the first encryption key and the second encryption key may include at least one of a symmetric key or a session key. The symmetric key is a key used to generate or decrypt ciphertext, and may be the same encryption key for decrypting encrypted data. Only parties sharing the symmetric key are able to decrypt encrypted information. The session key is an authentication method for user authentication, and is an encryption key used to maintain the security of session communication. The session key protects and encrypts communication between sessions to maintain security. When the first encryption key and the second encryption key are different, the first encryption key may be a public key and the second encryption key may be a private key. The public key and the private key may be asymmetric keys. The public key is used for encryption, and may be provided to a communication partner to securely transmit information. The private key is used for decryption, and may be used only by a party that owns the key to decrypt information.

The terminal 120 may generate encrypted information by secondly encrypting the identification information of the second non-fungible token and the address of the smart contract which are first encrypted, based on first time information (S313). The first time information may correspond to a first time interval corresponding to a time when the terminal 120 encrypts the identification information of the second non-fungible token.

Time information may be an arbitrary value generated in each time interval. For example, the time information may include a value of 130293 corresponding to a time interval between 10:01:00 and 10:01:59 and a value of 920313 corresponding to a time interval between 10:02:00 and 10:02:59, which is the next time interval. Therefore, according to a certain rule, the time information is a value generated in each time interval, and all values generated in a specific time interval may be the same regardless of in which device the values are generated. For example, in the time interval between 10:01:00 and 10:01:59, the same value of 130293 may be generated in the reader 110 and the terminal 120. In the present disclosure, for convenience of explanation, the first time information is referred to as time information generated in the terminal 120, and second time information is referred to as time information generated in the reader 110.

Since the terminal 120 generates the encrypted information, based on the first time information, different encrypted information may be generated in each time interval. In a case where different encrypted information is generated in each time interval, when the reader 110 does not recognize a code within a certain time from a time when the time information is generated, the reader 110 determines the code as invalid, and thus the user has no choice but to generate the code at the time of entering an event. In this case, since there is a restriction that the user needs to generate the code to be immediately recognized by the reader 110, the user may enter the event with only the ticket owned by the user. Accordingly, the user is allowed to use only the ticket owned by the user and cannot sell the ticket to another user, thus preventing illegal ticket resale of purchasing a large number of tickets at once and then selling the tickets to other users at a high price. In addition, since time information is generated in each time interval, even though communication through the terminal 120 and the computer network 150 is disconnected, the node device 142 may safely determine the validity of the ticket.

The terminal 120 may generate a code corresponding to the encrypted information, and may display the code on a screen (S314).

In an embodiment, the reader 110 may recognize the code to obtain the encrypted information (S331). A time at which operation S331 is performed may be after a time at which communication between the terminal 120 and the computer network 150 is not possible (301). The reader 110 may transmit a transaction for a request to determine whether the code is valid to the address of the smart contract (S332). In another embodiment, operation S331 and operation S332 may also be performed at a time when communication between the terminal 120 and the computer network 150 is possible.

When the transaction is transmitted to the address of the smart contract, the node device 142 may execute the smart contract. The smart contract may include instructions to determine whether the code is valid, based on first ticket information including information corresponding to each of one or more first non-fungible tokens minted in association with the event and the encrypted information, upon the encrypted information corresponding to the code from the reader having recognized the code. The node device 142 may execute the smart contract, thereby obtaining the encrypted information corresponding to the code (S352). The smart contract may further include instructions to decrypt the encrypted information to obtain at least one of the address of the smart contract or the identification information of the second non-fungible token. The instruction to decrypt the encrypted information to obtain at least one of the address of the smart contract or the identification information of the second non-fungible token may include instructions to first decrypt the encrypted information, based on the second time information for a second time interval corresponding to a time when the encrypted information is decrypted, and instructions to secondly decrypt the first decrypted encrypted information, based on the second encryption key associated with the first encryption key and stored in the smart contract. Accordingly, the node device 142 may first decrypt the encrypted information, based on the second time information by executing the smart contract (S353). Further, the node device 142 may secondly decrypt the firstly decrypted encrypted information, based on the second encryption key associated with the first encryption key, by executing the smart contract, thereby obtaining the identification information of the second non-fungible token and the address of the smart contract (S354).

In an embodiment, the instruction to determine whether the code is valid included in the smart contract may include instructions to determine that the code is invalid when decryption of the encrypted information fails. For example, a case where the decryption of the encrypted information fails may include a case where the encrypted information is decrypted based on the second encryption key not associated with the first encryption key. In another example, the case where the decryption of the encrypted information fails may include a case where the decryption fails because the first time interval and the second time interval are different. For example, when the first time interval is 10:05:00 to 10:05:59 and the second time interval is 10:07:00 to 10:07:59, the first time interval and the second time interval are different, and thus the node device 142 may fail in the decryption. When the first time interval and the second time interval are different, the first time information and the second time information are different, and thus the node device 142 may fail to decrypt the encrypted information.

The instruction to determine whether the code is valid included in the smart contract may include instructions to determine whether the code is valid, based on at least one of the first ticket information, the address of the smart contract, or the identification information of the second non-fungible token. Accordingly, the node device 142 may determine whether the code is valid, based on the first ticket information, the identification information of the second non-fungible token, and the address of the smart contract by executing the smart contract (S355). Hereinafter, various methods for determining whether the code is valid are described.

The instruction to determine whether the code is valid included in the smart contract may include instructions to determine whether identification information of a non-fungible token matching the identification information of the second non-fungible token exists in the first ticket information and determine that the code is valid according to determination that the identification information of the non-fungible token matching the identification information of the second non-fungible token exists in the first ticket information. The node device 142 may determine whether the identification information of the non-fungible token matching the identification information of the second non-fungible token exists in the first ticket information by executing the smart contract. The first ticket information may include identification data corresponding to each of the one or more first non-fungible tokens. For example, the first ticket information may include 500 pieces of identification information respectively corresponding to 500 first non-fungible tokens. The node device 142 may determine whether the identification information of the second non-fungible token included in second ticket information exists among the 500 pieces of identification information. The node device 142 may determine that the code is valid according to determination that the identification information of the second non-fungible token exists in the first ticket information. On the contrary, the node device 142 may determine that the code is invalid according to determination that the identification information of the second non-fungible token does not exist in the first ticket information. Accordingly, the node device 142 may determine whether the ticket corresponding to the code is an actually sold ticket by using the identification information of the second non-fungible token.

In another embodiment, the node device 142 may determine whether the code is valid, based on whether ownership information about the ticket exists in the first ticket information. The instruction to determine whether the code is valid included in the smart contract may include instructions to obtain identification information of the user, determine whether a correspondence between the identification information of the second non-fungible token and the identification information of the user exists in the first ticket information, and determine that the code is valid according to determination that the correspondence exists in the first ticket information. The reader 110 may receive the identification information of the user from the terminal 120 while recognizing the code. Accordingly, the node device 142 may obtain the identification information of the user from the reader 110. The ownership information about the ticket may be expressed as the correspondence between the identification information of the second non-fungible token and the identification information of the user, and the correspondence may be included in the first ticket information. The node device 141 may determine whether the correspondence between the identification information of the second non-fungible token and the identification information of the user exists in the first ticket information by executing the smart contract. For example, the node device 142 may determine whether a correspondence between the identification information of the second non-fungible token and an ID of the user exists in the first ticket information. In another example, the node device 142 may determine whether a correspondence between the identification information of the second non-fungible token and a wallet address of the user exists in the first ticket information. The node device 142 may determine that the code is valid according to determination that the correspondence exists in the first ticket information. On the contrary, the node device 142 may determine that the code is invalid according to determination that the correspondence does not exist in the first ticket information. Accordingly, the node device 142 may determine the validity of the ticket by using the ownership information about the ticket and the information related to the non-fungible token.

In an embodiment, the smart contract may further include instructions to update the first ticket information, based on a change in the identification information of the user that corresponds to the identification information of the second non-fungible token. For example, when a first user transfers the ticket to a second user, the node device 142 may update the user identification information corresponding to the identification information of the second non-fungible token from that about the first user to that about the second user. The node device 142 may reflect an update result in the first ticket information, and transmit the first ticket information with the update result reflected to a server 130. However, for the first user to transfer the ticket to the second user, there may be a restriction that both a terminal of the first user and a terminal of the second user need to be connected to the computer network 150, because a transaction regarding the change in the identification information of the user needs to be transmitted to the address of the smart contract in order to reflect the change in the identification information of the user that corresponds to the identification information of the second non-fungible token.

The instruction to determine whether the code is valid included in the smart contract may include instructions to determine whether the code is valid, based on the updated first ticket information and the encrypted information. The node device 142 may execute the smart contract, thereby determining whether the code is valid by using the first ticket information reflecting the change in ownership of the ticket. Accordingly, the users may freely trade tickets even just before the start time of the event as long as the terminal 120 is connected to the computer network 150. Even though the ticket is traded and the ownership of the ticket is changed, the node device 142 updates the first ticket information to reflect the change in the ownership of the ticket, and determines the validity of the code, based on the updated first ticket information.

In another embodiment, the node device 142 may determine whether the code is valid by identifying the event. A method for identifying the event may include identifying the address of the smart contract, because an address of a smart contract may be different for each event. The instruction to determine whether the code is valid included in the smart contract may include instructions to determine whether the address of the smart contract obtained by decrypting the encrypted information matches an address of a smart contract included in the first ticket information and determine that the code is valid according to determination that the address of the smart contract obtained by decrypting the encrypted information matches the address of the smart contract included in the first ticket information. The reader 110 may determine whether an address of a smart contract included in the second ticket information matches the address of the smart contract included in the first ticket information. The node device 142 may execute the smart contract, thereby determining that the code is valid according to determination that the address of the smart contract obtained by decrypting the encrypted information matches the address of the smart contract included in the first ticket information. On the contrary, the node device 142 may determine that the code is invalid according to determination that the address of the smart contract obtained by decrypting the encrypted information does not match the address of the smart contract included in the first ticket information. Accordingly, the node device 142 may execute the smart contract to identify the event, thereby determining the validity of the ticket.

In an embodiment, the node device 142 may transmit a result of determining whether the code is valid to the reader device 110 (S356). The reader device 110 may receive the determination result, and may display whether the code is valid on the screen (S333).

As the reader 110 is connected to the computer network 150 and requests the transaction to the address of the smart contract, the node device 142 may execute the smart contract to determine the validity of the ticket and transmit the determination result to the reader. Accordingly, since the identification information of the second non-fungible token and the address of the smart contract are enough as pieces of information included in the encrypted information exchanged between the terminal 120, the reader 110, and the node devices 141 and the reader 110 may receive additional information, such as ticket-related metadata, from the node devices 141 after the validity of the ticket is verified, the encrypted information may be lightened. Further, since the reader 110 is connected to the computer network 150, there is no need to set a restriction of limiting trading of tickets from a certain time prior to the start time of the event, because the node devices 141 execute the smart contract to determine the validity of tickets, and use the first ticket information updated in real time by reflecting changes in ownership due to trading of tickets to determine the validity of the tickets.

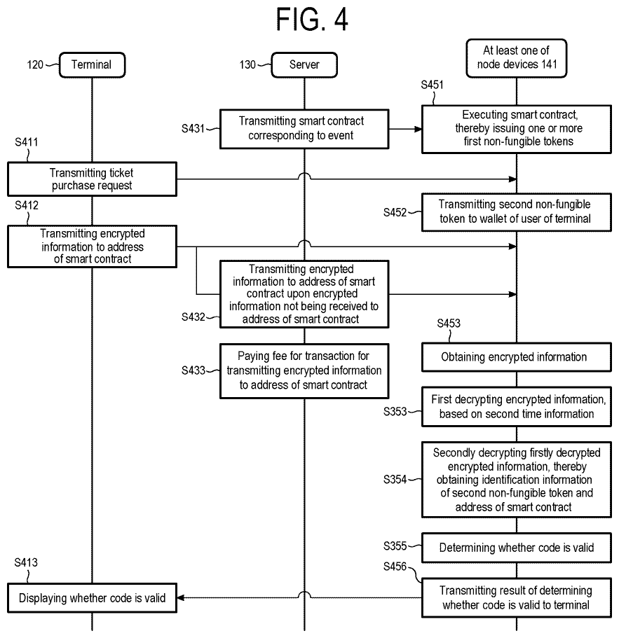

FIG. 4 is a flowchart illustrating a method in which a terminal transmits encrypted information to an address of a smart contract and a node device determines the validity of a ticket according to various embodiments of the present disclosure.

In an embodiment, a server 130 may transmit a smart contract corresponding to an event to a blockchain network 140. The smart contract may include instructions to mint one or more first non-fungible tokens, based on the number of tickets for the event and store first ticket information including information corresponding to each of the one or more first non-fungible tokens in the blockchain upon receiving a ticket issuance request from the server. A node device 142 may execute the smart contract, thereby minting the one or more first non-fungible tokens corresponding to the selected number of tickets (S451). The node device 142 may store the first ticket information in the blockchain. The node device 142 may transmit the first ticket information to the server 130.

In an embodiment, a terminal 120 may transmit a ticket purchase request (S411). The terminal 120 may transmit the ticket purchase request to the server 130 or to an address of the smart contract. When the ticket purchase request is transmitted to the server 130, the server 130 may transmit the ticket purchase request to the address of the smart contract. The smart contract may further include instructions to transmit a second non-fungible token, which is one of the one or more first non-fungible tokens, to a wallet of a user upon receiving the ticket purchase request from the user. The node device 142 may execute the smart contract, thereby transmitting the second non-fungible token, which is one of the one or more first non-fungible tokens, to the wallet of the user of the terminal 120 (S452). Further, the smart contract may include instructions to transmit at least one of the address of the smart contract or identification information of the second non-fungible token to the terminal 120. The node device 142 may execute the smart contract, thereby transmitting at least one of the identification information of the second non-fungible token or the address of the smart contract to the terminal 120. The identification information of the second non-fungible token may be the identification information of the second non-fungible token transmitted to the wallet of the user.

In an embodiment, the terminal 120 may be in a situation of being able to communicate with a computer network 150. When the terminal 120 is able to communicate with the computer network 150, the terminal 120 may transmit a transaction for determining the validity of a ticket directly to the address of the smart contract. For example, the terminal 120 may transmit encrypted information to the address of the smart contract (S412). The encrypted information may be information encrypted by the terminal, based on at least one of the identification information of the second non-fungible token or the address of the smart contract.

However, the terminal 120 may fail to transmit the transaction. In this case, node devices 141 may not receive the transaction, and may thus not obtain the encrypted information generated by the terminal 120. The server 130 may monitor the transaction transmitted by the terminal 120 to the address of the smart contract. The server 130 may retransmit the transaction to the address of the smart contract upon the result of transaction transmission failure. For example, the server 130 may transmit the encrypted information to the address of the smart contract upon the encrypted information not being received to the address of the smart contract (S432). Accordingly, the transaction transmitted by the terminal 120 may be successfully received to the address of the smart contract, thus determining the validity of the ticket for the user.

The smart contract may further include instructions to cause the server 130 to pay a fee for the transaction for the terminal 120 to transmit the encrypted information to the address of the smart contract. When the transaction is transmitted, the fee (e.g., a mining fee) may be incurred. The node device 142 may transmit a signal to cause the server 130 to pay the fee to the server 130. The server 130 may receive the signal, and may cause the fee to be withdrawn from a wallet corresponding to the server 130 or a wallet for paying the fee. Accordingly, the validity of the ticket may be determined for free for the user.

The smart contract may include instructions to obtain the encrypted information from the terminal 120 or the server 130. The node device 142 may execute the smart contract, thereby obtaining the encrypted information from the server 130 or the terminal 120 (S453). Since the following operations S353 to S355 have been described above with reference to FIG. 3, a detailed description of the operations is omitted in this drawing.

In an embodiment, the node device 142 may transmit the result of determining whether a code is valid to the terminal 120 (S456). The terminal 120 may receive the result of determining whether the code is valid, and may display whether the code is valid on a screen (S413).

In the present disclosure, when the terminal 120 is able to communicate with the computer network 150, the terminal 120 may transmit the transaction directly to the address of the smart contract to determine the validity of the ticket, and when the terminal 120 is unable to communicate with the computer network 150, the code may be recognized by a reader 110 to determine the validity of the ticket. Therefore, it is possible to smoothly determine the validity of the ticket regardless of whether communication with the computer network 150 is possible at the venue of the event.

Further, the terminal 120 of the present disclosure may transmit the transaction for a request to determine the validity of the ticket directly to the address of the smart contract without using the reader 110, thereby reducing the number of readers installed at the venue of the event. For example, when there are 100,000 users attending a specific event, hundreds of readers may be needed to admit the 100,000 people within one hour. However, when the terminal 120 transmits a transaction for requesting ticket validity determination directly to the address of the smart contract and displays a determination result on the screen of the terminal 120, a large number of readers are not needed, and the reader 110 may be used restrictively in a situation where communication between the terminal 120 and the computer network 150 is impossible.

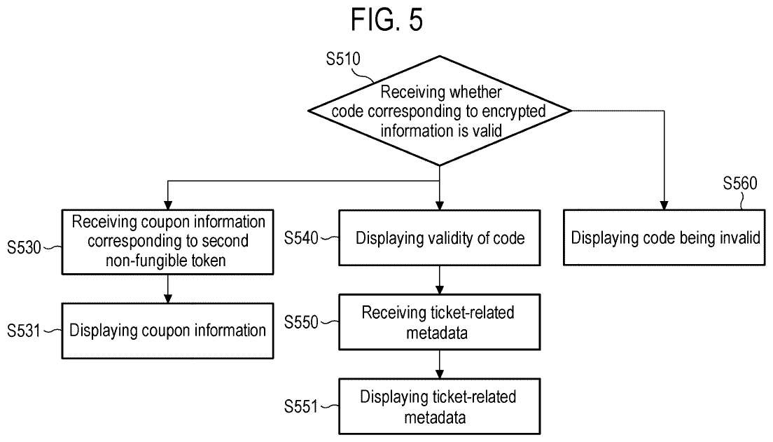

FIG. 5 is a flowchart illustrating a screen display method of a reader according to the result of determining the validity of a ticket according to various embodiments of the present disclosure. In an embodiment, a reader 110 may receive whether a code corresponding to encrypted information is valid (S510). The reader may display the validity of the code on a screen according to determination that the code is valid (S540). For example, the reader 110 may display a color (e.g., green) indicating that the code is valid on the screen. In another example, the reader 110 may display text indicating that a ticket is valid (e.g., the ticket has been confirmed) on the screen.

In an embodiment, a smart contract may include instructions to transmit ticket-related metadata corresponding to a second non-fungible token to the reader 110 according to the determination that the code is valid. A node device 142 may execute the smart contract, thereby transmitting the ticket-related metadata corresponding to the second non-fungible token to the reader 110. The ticket-related metadata may include information about at least one of the name of an event, a schedule, a location, a seat identifier of the ticket, a price, a purchase condition, or a user. The reader 110 may receive the ticket-related metadata (S550). The reader 110 may display the received ticket-related metadata on the screen (S551). In another embodiment, the reader 110 may transmit the received ticket-related metadata to a terminal 120.

In an embodiment, the smart contract may further include instructions to transmit a signal enabling a server to transmit coupon information corresponding to the second non-fungible token to the reader according to the determination that the code is valid. A coupon refers to a discount voucher or certificate that provides a discount or additional benefit for a product or service. The coupon information may refer to any information related to the coupon. The coupon information may include various coupons, such as a discount rate or discount amount for a product purchasable at the event and a free gift related to the event. The node device 142 may execute the smart contract, thereby transmitting the signal enabling the server 130 to transmit the coupon information corresponding to the second non-fungible token to the reader 110 to the server 130. The coupon information may be stored in the server 130 instead of being stored in a blockchain network 140. The coupon information may have a large size not to be stored in the blockchain network 140 depending on the type and/or number of coupons. Therefore, the server 130 may identify the coupon information corresponding to the second non-fungible token, and may transmit the coupon information to the reader 110. The reader 110 may display the coupon information on the screen (S531). The reader 110 may transmit the coupon information to the terminal 120.

In an embodiment, the reader 110 may display the code being invalid on the screen upon determining that the code is invalid (S560). For example, the reader 110 may display a color (e.g., red) indicating that the code is invalid on the screen. In another example, the reader 110 may display text indicating that the ticket is invalid (e.g., the ticket is invalid) on the screen.

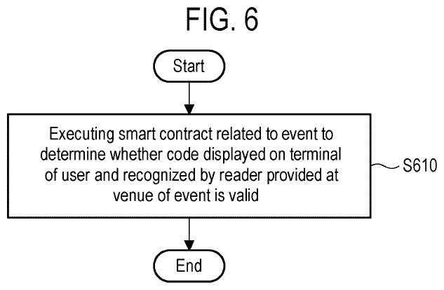

FIG. 6 is a flowchart illustrating a method in which a node device determines the validity of a ticket according to various embodiments of the present disclosure. In an embodiment, the node device 142 may execute a smart contract related to an event to determine whether a code displayed on a terminal 120 of a user and recognized by a reader 110 installed at the venue of the event is valid (S610).

In an embodiment, the smart contract may include instructions to determine whether the code is valid, based on first ticket information including information corresponding to each of one or more first non-fungible tokens minted in association with the event and encrypted information, upon obtaining the encrypted information corresponding to the code from the reader 110 that recognizes the code.

The encrypted information may be information encrypted by the terminal 120, based on at least one of identification information of a second non-fungible token, which is one of the one or more first non-fungible tokens, or an address of the smart contract.

In an embodiment, the smart contract may include instructions to mint the one or more first non-fungible tokens, based on the number of tickets for the event, upon receiving a ticket issuance request from a server, and store the first ticket information including the information corresponding to each of the one or more first non-fungible tokens in a blockchain.

In an embodiment, the smart contract may further include instructions to transmit the second non-fungible token, which is one of the first non-fungible tokens, to a wallet of the user upon receiving a ticket purchase request from the user.

In an embodiment, the smart contract may include instructions to transmit at least one of the address of the smart contract or the identification information of the second non-fungible token to the terminal.

In an embodiment, the smart contract may further include instructions to update the first ticket information, based on a change in identification information of the user that corresponds to the identification information of the second non-fungible token.

In an embodiment, the instruction to determine whether the code is valid may include instructions to determine whether the code is valid, based on the updated first ticket information and the encrypted information.

In an embodiment, the smart contract may further include instructions to decrypt the encrypted information to obtain at least one of the address of the smart contract or the identification information of the second non-fungible token.

In an embodiment, the instruction to determine whether the code is valid may include instructions to determine whether the code is invalid when the encrypted information fails to be decrypted.

In an embodiment, the instruction to determine whether the code is valid may include instructions to determine whether the code is valid, based on at least one of the first ticket information, the address of the smart contract, or the identification information of the second non-fungible token.

In an embodiment, the encrypted information is information encrypted based on a first encryption key and first time information for a first time interval corresponding to a time when the terminal 120 encrypts the identification information of the second non-fungible token.

In an embodiment, the instruction to decrypt the encrypted information to obtain at least one of the address of the smart contract or the identification information of the second non-fungible token may include instructions to first decrypt the encrypted information, based on second time information for a second time interval corresponding to a time when the encrypted information is decrypted, and secondly decrypt the first decrypted encrypted information, based on a second encryption key associated with the first encryption key and stored in the smart contract.

In an embodiment, the instruction to determine whether the code is valid may include instructions to determine whether identification information of a non-fungible token matching the identification information of the second non-fungible token exists in the first ticket information and determine that the code is valid according to determination that the identification information of the non-fungible token matching the identification information of the second non-fungible token exists in the first ticket information.

In an embodiment, the instruction to determine whether the code is valid may include instructions to obtain the identification information of the user, determine whether a correspondence between the identification information of the second non-fungible token and the identification information of the user exists in the first ticket information, and determine that the code is valid according to determination that the correspondence exists in the first ticket information.

In an embodiment, the instruction to determine whether the code is valid may include instructions to determine whether the address of the smart contract obtained by decrypting the encrypted information matches an address of a smart contract included in the first ticket information and determine that the code is valid according to determination that the address of the smart contract obtained by decrypting the encrypted information matches the address of the smart contract included in the first ticket information.

In an embodiment, the smart contract may further include instructions to transmit ticket-related metadata corresponding to the second non-fungible token to the reader 110 according to determination that the code is valid.

In an embodiment, the smart contract may further include instructions to transmit a signal enabling the server 130 to transmit coupon information corresponding to the second non-fungible token to the reader 110 to the server 130 according to the determination that the code is valid.

In an embodiment, the smart contract may further include instructions to obtain the encrypted information from the terminal 120 or the server 130.

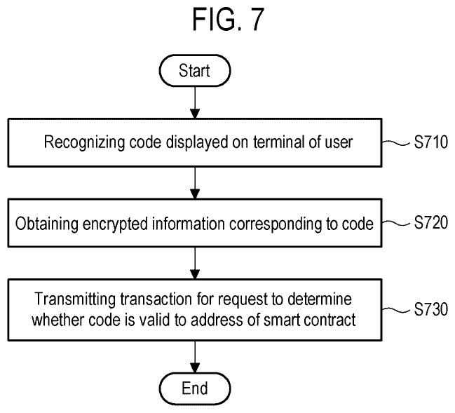

FIG. 7 is a flowchart illustrating the operation of a reader according to various embodiments of the present disclosure. In an embodiment, a reader 110 may recognize a code displayed on a terminal 120 of a user (S710). In an embodiment, the reader 110 may obtain encrypted information corresponding to the code from the terminal 120 (S720). In an embodiment, the reader 110 may transmit a transaction for a request to determine whether the code is valid to an address of a smart contract (S730). The transaction may include the encrypted information.

The smart contract may include instructions to determine whether the code is valid, based on first ticket information including information corresponding to each of one or more first non-fungible tokens and the encrypted information, upon obtaining the encrypted information corresponding to the code from the reader 110 that recognizes the code.

In an embodiment, an application that provides a service for trading the one or more first non-fungible tokens may be installed in the terminal 120. The code may be displayed through the application. Users may purchase a ticket corresponding to a second non-fungible token through the application. The users may transfer the ticket corresponding to the second non-fungible token to other users through the application.

In an embodiment, the code may be displayed on a screen of the terminal 120, based on the result of biometric authentication of the user performed on the terminal 120. Biometric authentication is an authentication method for identifying a person by utilizing a biometric characteristic of the person. This method is utilized for access control or user authentication by utilizing a biometric characteristic. Biometric authentication is based on various pieces of biometric information, such as a fingerprint, an iris, and facial recognition.

According to various embodiments of the present disclosure, in a situation where communication between a terminal and a server is impossible but a reader is connected to a computer network, the reader may transmit encrypted information obtained from the terminal to an address of a smart contract, thereby determining the validity of a ticket.

According to various embodiments of the present disclosure, even though a change in the ownership of a ticket is not limited from a certain time prior to the start time of an event, since a reader is connected to a computer network, a node device may execute a smart contract, thereby determining the validity of the ticket by reflecting a change in the ownership.

According to various embodiments of the present disclosure, in a situation where a terminal is connected to a computer network, the terminal may transmit encrypted information related to a ticket to an address of a smart contract and a node device may execute the smart contract, thereby determining the validity of the ticket.

According to various embodiments of the present disclosure, when a server monitors encrypted information about a terminal transmitted to an address of a smart contract and the encrypted information about the terminal is not transmitted to the address of the smart contract, the server may retransmit the encrypted information about the terminal to the address of the smart contract.

According to various embodiments of the present disclosure, it is possible to determine the validity of a ticket corresponding to a non-fungible token.

According to various embodiments of the present disclosure, it is possible to prevent an illegal transaction of a ticket corresponding to a non-fungible token.

According to various embodiments of the present disclosure, it is possible to prevent an illegal transaction of a ticket even in a situation where communication between a terminal and a computer network is impossible.

Although process steps, method steps, algorithms, or the like may be described in a sequential order, such processes, methods, and algorithms may generally be configured to work in any practical order. In other words, processes, methods, and algorithms described in various embodiments of the present disclosure may not necessarily be performed in the order described herein. Further, some steps may be performed simultaneously despite being described or implied as occurring non-simultaneously. Moreover, the illustration of a process by a depiction in a drawing does not imply that the illustrated process is exclusive of other variations and modifications thereto, does not imply that the illustrated process or any of its steps are necessary to one or more of various exemplary embodiments of the present disclosure, and does not imply that the illustrated process is preferred.

While the foregoing methods have been described with reference to particular embodiments, these methods may also be implemented as computer-readable codes on a computer-readable recording medium. The computer-readable recoding medium includes any kind of recording device that stores data readable by a computer system 10. Examples of the computer-readable recording medium include ROM, RAM, CD-ROM, a magnetic tape, a floppy disk, and an optical data storage device. Further, the computer-readable recoding medium may be distributed to the computer system 10 connected through a network, so that the computer-readable codes may be stored and executed in a distribution manner. In addition, functional programs, codes, and code segments for implementing the foregoing embodiments may easily be inferred by programmers in the art to which the present disclosure pertains.

What is claimed is:

1. A method performed in a node device including one or more processors and one or more memories that store instructions to be executed by the one or more processors by executing a smart contract, the method comprising:
determining, by the one or more processors, whether a code displayed on a terminal of a user and recognized by a reader provided at an event venue of an event is valid by executing the smart contract related to the event,
wherein the smart contract includes instructions to:
determine whether the code is valid, based on first ticket information including information corresponding to each of one or more first non-fungible tokens (NFTs) minted in association with the event and encrypted information, upon obtaining the encrypted information corresponding to the code from the reader that recognizes the code, and
wherein the encrypted information is information encrypted by the terminal, based on at least one of identification information of a second non-fungible token or an address of the smart contract,
wherein the second non-fungible token is one of the one or more first non-fungible tokens.

2. The method of claim 1, wherein the smart contract further includes instructions to:
mint the one or more first non-fungible tokens based on a number of tickets for the event, upon receiving a ticket issuance request from a server; and
store the first ticket information including the information corresponding to each of the one or more first non-fungible tokens in a blockchain.

3. The method of claim 1, wherein the smart contract further includes instructions to:
transmit the second non-fungible token to a wallet of the user upon receiving a ticket purchase request from the user.

4. The method of claim 1, wherein the smart contract includes instructions to:
transmit at least one of the address of the smart contract or the identification information of the second non-fungible token to the terminal.

5. The method of claim 1, wherein the smart contract further includes instructions to:
update the first ticket information based on a change in identification information of the user that corresponds to the identification information of the second non-fungible token.

6. The method of claim 5, wherein the instructions to determine whether the code is valid includes instructions to determine whether the code is valid based on the updated first ticket information and the encrypted information.

7. The method of claim 1, wherein the smart contract further includes instructions to:
decrypt the encrypted information to obtain at least one of the address of the smart contract or the identification information of the second non-fungible token.

8. The method of claim 7, wherein the instructions to determine whether the code is valid includes instructions to determine whether the code is invalid when the encrypted information fails to be decrypted.

9. The method of claim 7, wherein the instructions to determine whether the code is valid includes instructions to determine whether the code is valid, based on at least one of the first ticket information, the address of the smart contract, or the identification information of the second non-fungible token.

10. The method of claim 7, wherein the encrypted information is information encrypted based on a first encryption key and first time information for a first time interval corresponding to a time when the terminal encrypts the identification information of the second non-fungible token, and
the instructions to decrypt the encrypted information to obtain at least one of the address of the smart contract or the identification information of the second non-fungible token includes:
instructions to first decrypt the encrypted information, based on second time information for a second time interval corresponding to a time when the encrypted information is decrypted; and
instructions to secondly decrypt the first decrypted encrypted information, based on a second encryption key associated with the first encryption key and stored in the smart contract.

11. The method of claim 1, wherein the instructions to determine whether the code is valid includes instructions to:
determine whether identification information of a non-fungible token matching the identification information of the second non-fungible token exists in the first ticket information; and
determine that the code is valid according to determination that the identification information of the non-fungible token matching the identification information of the second non-fungible token exists in the first ticket information.

12. The method of claim 1, wherein the instructions to determine whether the code is valid includes instructions to:
obtain the identification information of the user;
determine whether a correspondence between the identification information of the second non-fungible token and the identification information of the user exists in the first ticket information; and
determine that the code is valid according to determination that the correspondence exists in the first ticket information.

13. The method of claim 7, wherein the instructions to determine whether the code is valid includes instructions to:
determine whether the address of the smart contract obtained by decrypting the encrypted information matches an address of a smart contract included in the first ticket information; and
determine that the code is valid according to determination that the address of the smart contract obtained by decrypting the encrypted information matches the address of the smart contract included in the first ticket information.

14. The method of claim 1, wherein the smart contract further includes instructions to transmit ticket-related metadata corresponding to the second non-fungible token to the reader according to determination that the code is valid.

15. The method of claim 14, wherein the ticket-related metadata includes information about at least one of a name of the event, a schedule, a location, a seat identifier of a ticket, a price, a purchase condition, or the user.

16. The method of claim 1, wherein the smart contract further includes instructions to transmit a signal enabling a server to transmit coupon information corresponding to the second non-fungible token to the reader, to the server according to determination that the code is valid.

17. The method of claim 1, wherein the smart contract further includes instructions to obtain the encrypted information from the terminal or a server,
the encrypted information is transmitted from the terminal to the server, and
the server transmits the encrypted information to the address of the smart contract upon the encrypted information not being received to the address of the smart contract.

18. The method of claim 17, wherein the smart contract further includes instructions to cause the server to pay a fee for a transaction for the terminal to transmit the encrypted information to the address of the smart contract.

19. A method performed by a reader including one or more processors and one or more memories that store instructions to be executed by the one or more processors, the method comprising: by the one or more processors,
recognizing a code displayed on a terminal of a user;
obtaining encrypted information corresponding to the code, the encrypted information being information encrypted by the terminal, based on at least one of identification information of a second non-fungible token associated with an event, or an address of a smart contract; and
transmitting a transaction for a request to determine whether the code is valid to the address of the smart contract,
wherein the smart contract includes instructions to determine whether the code is valid, based on first ticket information including information corresponding to each of the one or more first non-fungible tokens and the encrypted information, upon obtaining the encrypted information corresponding to the code from the reader that recognizes the code, and
wherein the second non-fungible token is one of the one or more first non-fungible tokens.

20. The method of claim 19, wherein an application that provides a service for trading the one or more first non-fungible tokens is installed in the terminal, and
the code is displayed through the application.

21. The method of claim 19, wherein the code is displayed on a screen of the terminal, based on a result of biometric authentication of the user performed on the terminal.

22. A node device including:
one or more processors; and
one or more memories that store instructions to be executed by the one or more processors,
wherein, when the instructions are executed, the one or more processors determine whether a code displayed on a terminal of a user and recognized by a reader provided at an event venue of an event is valid by executing a smart contract related to the event,
wherein the smart contract includes instructions to determine whether the code is valid, based on first ticket information including information corresponding to each of one or more first non-fungible tokens (NFTs) minted in association with the event and encrypted information, upon obtaining the encrypted information corresponding to the code from the reader that recognizes the code,
wherein the encrypted information is information encrypted by the terminal, based on at least one of identification information of a second non-fungible token, or an address of the smart contract, and
wherein the second non-fungible token is one of the one or more first non-fungible tokens.
